(19) United States
(12) Patent Application Publication
(10) Pub. No.: US 2007/0093237 A1
(43) Pub. Date: Apr. 26, 2007

(54) Locating and identifying a person using a mobile device

(75) Inventor: Ryan Mitchell Bayne, Waterloo (CA)

Correspondence Address: INTEGRAL INTELLECTUAL PROPERTY INC., 44 LONGWOOD DRIVE, TORONTO, ON, M3B 1T8, CA

(73) Assignee: Research In Motion Limited, Waterloo, ON (CA)

(21) Appl. No.: 11/258,022

(22) Filed: Oct. 26, 2005

(51) Int. Cl. H04Q 7/22

(52) U.S. Cl. 455/414.2

(57) ABSTRACT

A mobile device communicates wirelessly with a smart card reader to obtain-identification of a person whose smart card is coupled to the smart card reader. The mobile device transmits the identification to a server via a network. The mobile device also transmits information about its location to the server. The server determines the identity and location of the person that is using the mobile device.

### BACKGROUND

Transferable mobile communication devices, for example, walkie-talkies, may be picked up by employees for their use at the beginning of a shift and returned at the end of the shift. Some of these devices may include a global positioning system (GPS) receiver, and may therefore be able to calculate their location. Such a device may transmit information about its location to a server on a network so that the employer knows where the device is located. However, the employer may still not know which device is with which employee, and therefore will not know where each employee is located at any given time.

### BRIEF DESCRIPTION OF THE DRAWINGS

Embodiments are illustrated by way of example and not limitation in the figures of the accompanying drawings, in which like reference numerals indicate corresponding, analogous or similar elements, and in which:

FIG. 1 is an illustration of an exemplary environment in which mobile communications devices are transferable among different users, and users have smart cards coupled to smart card readers, according to some embodiments;

FIG. 2 is a schematic diagram of an exemplary system comprising a server coupled to a network, mobile communication devices, smart card readers and smart cards, according to some embodiments;

FIG. 3 is a flowchart of an exemplary method for locating and identifying a user of a mobile communications device; and

FIG. 4 is a block diagram of some components of the exemplary system of FIG. 2, according to some embodiments.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of the embodiments. However it will be understood by those of ordinary skill in the art that the embodiments may be practiced without these specific details. In other instances, well-known methods, procedures, components and circuits have not been described in detail so as not to obscure the embodiments.

J In some situations, mobile communication devices may be transferable among different users. For example, an employee may take a mobile communication device from a common pool at the start of a shift and return it at the end of the shift, at which point the device is available to be taken by a different employee. A non-exhaustive list of examples of such situations includes employees in amusement parks, security guards at a stadium or shopping mall, employees in a large hospital, park rangers, police officers and/or other emergency personnel and the like.

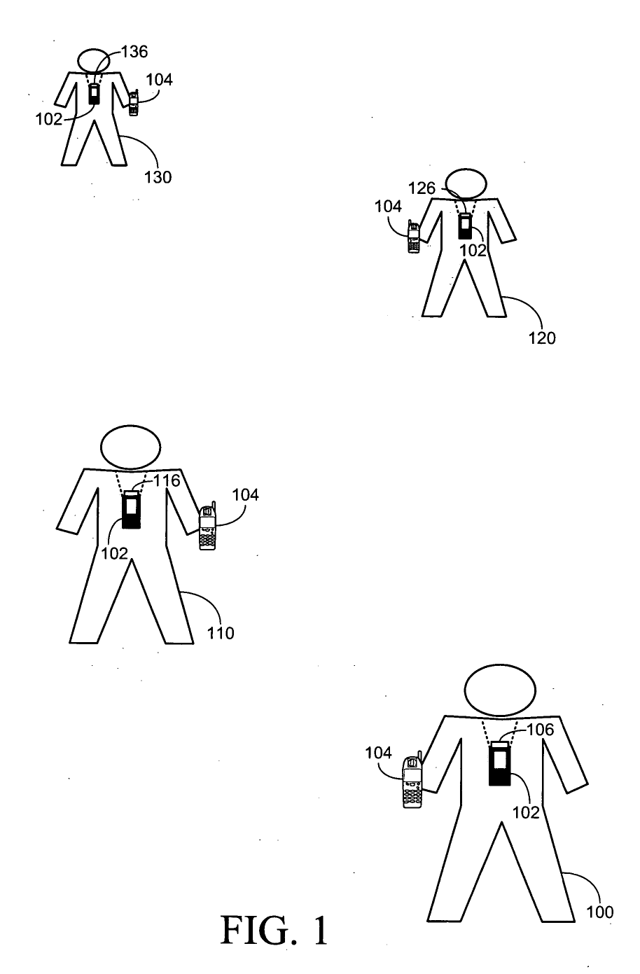

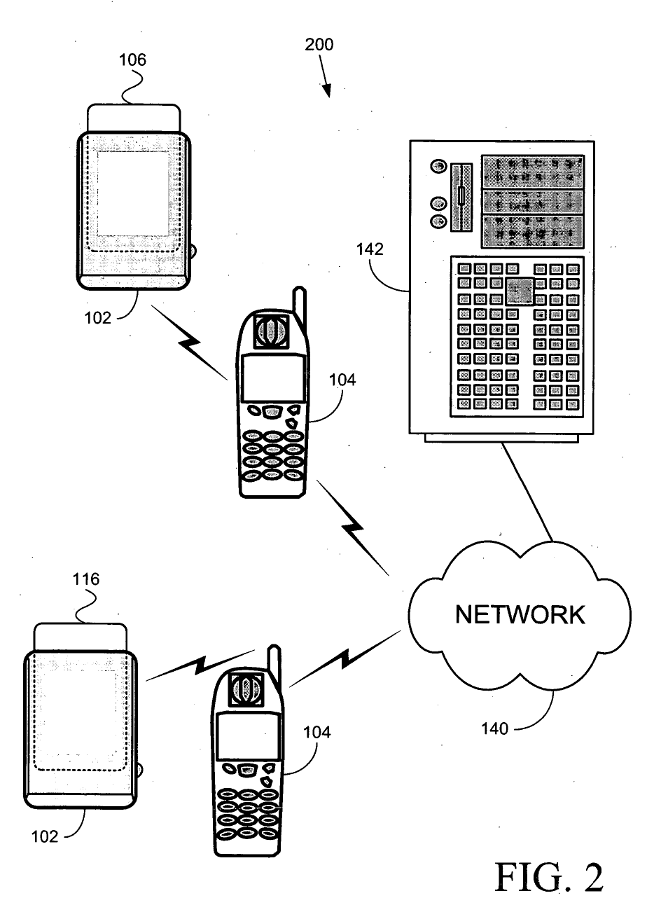

FIG. 1 is an illustration of an exemplary environment in which mobile communications devices are transferable among different users, and users have smart cards coupled to smart card readers, according to some embodiments. FIG. 2 is a schematic diagram of an exemplary system 200 used in such environments, according to some embodiments.

Four employees are shown in FIG. 1 at various locations in their place of employment, for example, a theme park. Employees 100, 110, 120 and 130 each have a smart card reader 102 and a mobile communication device 104. Employee 100 has a smart card 106 coupled to smart card reader 102. Similarly, employees 110, 120 and 130 have respective smart cards 116, 126 and 136 coupled to their smart card readers.

At the beginning of the shift, employee 100 picked up a particular mobile device from the common pool, while employee 110 picked up another mobile device from the common pool. The mobile device picked up by employee 100 may be the same as or different from the mobile device picked up by employee 110. In general, there is nothing about the mobile device that uniquely identifies the employee that is currently using it.

Smart cards 106, 116, 126 and 136 store identifying data of employees 100, 110, 120 and 130, respectively. Smart cards are personalized security devices, defined by the ISO7816 standard and its derivatives, as published by the International Organization for Standardization. A smart card may have a form factor of a credit card and may include a semiconductor device. The semiconductor device may include a memory that can be programmed with security information (e.g., a private decryption key, a private signing key, biometrics, etc.) and may include a processor and/or dedicated logic, for example, dedicated decryption logic and/or dedicated signing logic. A smart card may include a connector for powering the semiconductor device and performing serial communication with an external device. Alternatively, smart card functionality may be embedded in a device having a different form factor and different communication protocol, for example a Universal Serial Bus (USB) device. A smart card may also include a random number generator. A smart card may be used for visual identification, time cards, door access, and the like.

Smart card readers 102 may be able to communicate wirelessly with mobile devices 104 using a first wireless communication protocol. A non-exhaustive list of examples of the first wireless communication protocol includes the Bluetooth® protocol, the ultra wideband (UWB) protocol, the ZigBee™ protocol and the like.

Mobile devices 104 may be able to communicate with a network 140 using a second, different, wireless communication protocol. A non-exhaustive list of examples of the second wireless communication protocol includes cellular telephone protocols, wireless local area network (WLAN) protocols such as IEEE 802.11, and the like.

A server 142 is coupled to network 140. Server 142 may be able to identify the locations of mobile devices 104. For example, if mobile devices 104 communicate with network 140 using a WLAN protocol, server 142 may be able to calculate the location of a particular mobile device 104 from the locations of access points and from information about the received signal strength at the particular mobile device 104 of signals originating at the access points. In another example, a mobile device 104 may include a global positioning system (GPS) receiver that calculates the location of the mobile device using GPS signals received by the mobile device.

Suppose a guest of the theme park requires immediate emergency assistance. Server 142 may be able to identify which employees are located nearby (and therefore enable the appropriate employees to be instructed to assist the guest) if it has location information for mobile devices 104 and can determine which employees have which devices.

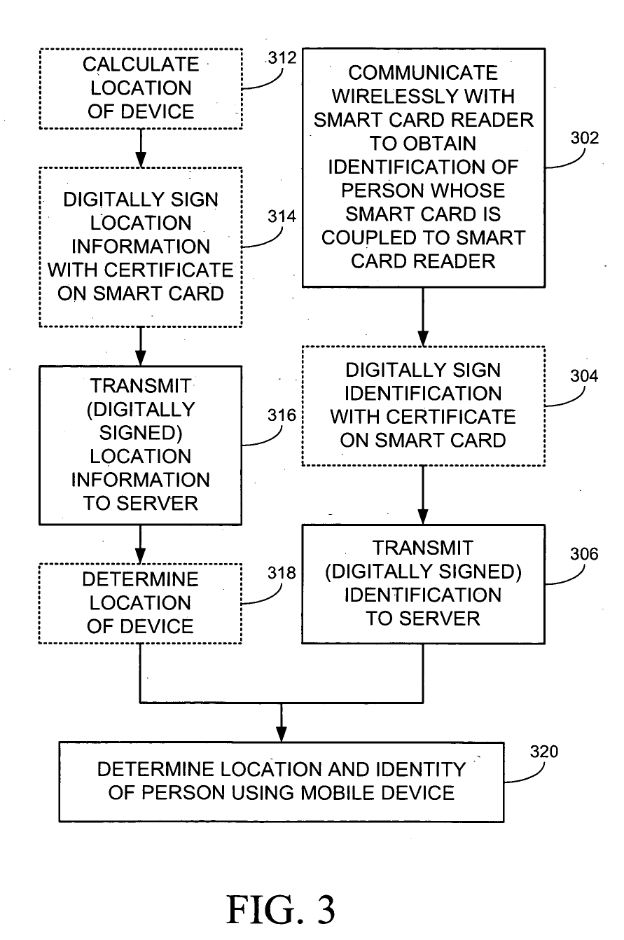

FIG. 3 is a flowchart of an exemplary method for locating and identifying a user of a mobile communications device, according to some embodiments.

At 302, mobile device 104 communicates wirelessly with smart card reader 102 to obtain identification of the person whose smart card is coupled to smart card reader 102. For example, the mobile device 104 used by employee 100 communicates with the smart card reader 102 worn by employee 100 to obtain identification of employee 100 from smart card 106.

At 304, the identification of the person may be digitally signed by a certificate stored in smart card 106.

At 306, the identification of the person, possibly digitally signed, is transmitted from mobile device 104 to server 142 via network 140.

At 312, mobile device 104 may calculate its location, for example, using received GPS signals.

At 314, information related to the location of mobile device 104 may be digitally signed by the certificate stored in smart card 106.

At 316, the location information, possibly digitally signed, is transmitted from mobile device 104 to server 142 via network 140. The information related to the location may be an indication of the location calculated at 312. Alternatively, this information may be other location information used by server 142 to determine the location of mobile device 104. For example, the information may be information about the received signal strength at mobile device 104 of signals originating at access points in network 140, for example RSSI (received signal strength indication) information. In the latter case, at 318, server 142 may determine the location of mobile device 104 using, the information transmitted at 316 and with other information available to server 142.

The location information may be transmitted together with the identification in a single transmission, or separately.

At 320, server 142 determines the location and identity of the person using mobile device 104 from the information transmitted at 306 and 316. The location of mobile device 104 determined at 312 or 318 is the location of the person using mobile device 104. It is assumed that the person using mobile device 104 is the person whose smart card is coupled to the smart card reader that communicates wirelessly with mobile device 104.

Digitally signing the identification information and/or the location information by the certificate stored in smart card 106 *authenticates the information so that the recipient, server 142 in this case, is confident that the information originates at smart card 106. For example, to add a digital signature to the information being sent by mobile device 104, mobile device 104 may wirelessly communicate a hash of the contents of the information to smart card reader 102. Smart card reader 102 may pass the hash to smart card 106, which may produce a digital signature from the hash and the sender's private signing key, which is stored in smart card 106. Smart card 106 may then pass the digital signature to smart card reader 102, which may communicate it wirelessly to mobile device 104 so that mobile device 104 can transmit it along with the information. Smart card 106 may prevent unauthorized use of the recipient's private signing key by requiring that a password or PIN be supplied before allowing the signing operation to proceed. The wireless communication link between smart card reader 102 and mobile device 104 may be secured using cryptographic techniques.

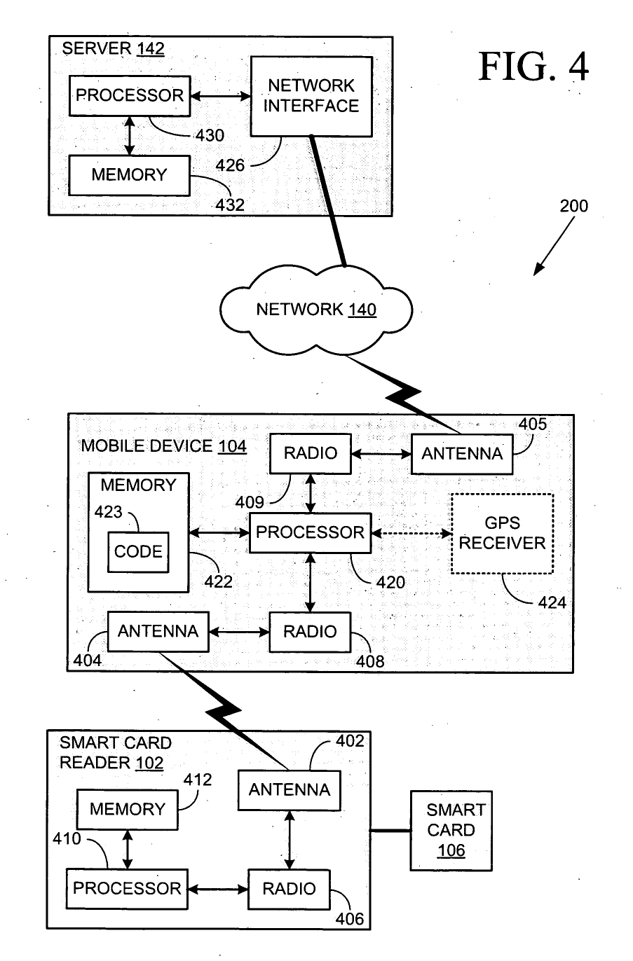

FIG. 4 is a block diagram of some components of the exemplary system 200 of FIG. 2. Smart card reader 102 includes an antenna 402 and mobile device 104 includes antennae 404 and 405. A non-exhaustive list of examples for antennae 402, 404 and 405 includes dipole antennae, monopole antennae, multilayer ceramic antennae, planar inverted-F antennae, loop antennae, shot antennae, dual antennae, omnidirectional antennae and any other suitable antennae.

Smart card reader 102 includes a radio 406 coupled to antenna 402, and mobile device 104 includes radios 408 and 409 coupled to antennae 404 and 405, respectively. Radios 406 and 408 are compatible with a first wireless communication protocol. Radio 409 is compatible with a second, different, wireless communication protocol. A non-exhaustive list of examples of the first wireless communication protocol includes the Bluetooth® protocol, the ultra wideband (UWB) protocol, the ZigBee™ protocol and the like. A non-exhaustive list of examples of the second wireless communication protocol includes cellular telephone protocols, wireless local area network (WLAN) protocols such as IEEE 802.11, and the like.

Smart card reader 102 also includes a processor 410 coupled to radio 406, and a memory 412, which may be fixed in or removable from smart card reader 102. Memory 412 may be embedded or partially embedded in processor 410. Processor 410 and memory 412 may be part of the same integrated circuit or in separate integrated circuits. Radio 406 and processor 410 may be part of the same integrated circuit or in separate integrated circuits.

Mobile device 104 also includes a processor 420 coupled to radios 408 and 409, and a memory 422, which may be fixed in or removable from mobile device 104. Memory 422 may be embedded or partially embedded in processor 420. Processor 420 and memory 422 may be part of the same integrated circuit or in separate integrated circuits. Processor 420 and one or more of radios 408 and 409 may be part of the same integrated circuit or in separate integrated circuits.

Mobile device 104 may include a GPS receiver 424 coupled to processor 420. 100331 Server 142 includes a network interface 426, a processor 430 coupled to network interface 426, and a memory 432, which may be fixed in or removable from server 142. Memory 432 may be embedded or partially embedded in processor 430. Processor 430 and memory 432 may be part of the same integrated circuit or in separate integrated circuits. Processor 430 and network interface 426 may be part of the same integrated circuit or in separate integrated circuits.

A non-exhaustive list of examples for processors 410, 420 and 430 includes a central processing unit (CPU), a digital signal processor (DSP), a reduced instruction set computer (RISC), a complex instruction set computer (CISC) and the like. Furthermore, each of processors 410, 420 and 430 may be part of an application specific integrated circuit (ASIC) or may be a part of an application 'specific standard product (ASSP).

A non-exhaustive list of examples for memories 412, 422 and 432 includes any combination of the following:
a) semiconductor devices such as registers, latches, read only memory (ROM), mask ROM, electrically erasable programmable read only memory devices (EEPROM), flash memory devices, non-volatile random access memory devices (NVRAM), synchronous dynamic random access memory (SDRAM) devices, RAMBUS dynamic random access memory (RDRAM) devices, double data rate (DDR) memory devices, static random access memory (SRAM), universal serial bus (USB) removable memory, and the like;
b) optical devices, such as compact disk read only memory (CD ROM), and the like; and
c) magnetic devices, such as a hard disk, a floppy disk, a magnetic tape, and the like.

Memory 422 may store executable code 423 which, when executed by processor 420, may cause mobile device 104 to implement portions of the methods described hereinabove. 10037] Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile communication device comprising:
a first radio through which said device is able to communicate with a network using a first wireless communication protocol;
a second radio through which said device is able to communicate with a smart card reader using a second, different, wireless communication protocol, said smart card reader able to be coupled to a smart card that stores identifying data of a person;
a processor; and
a memory to store code which, when executed by said processor, transmits information related to a location of said device through said first radio to said network and transmits an identification of said person through said first radio to said network.

2. The mobile device of claim 1, further comprising:
a global positioning system receiver to calculate said location.

3. The mobile device of claim 1, wherein said code, when executed by said processor, transmits said information digitally signed by a certificate stored on said smart card and transmits said identification of said person digitally signed by said certificate.

4. The mobile device of claim 1, wherein said second communication protocol is a Bluetooth® protocol.

5. The mobile device of claim 1, wherein said second communication protocol is an ultra wideband (UWB) protocol.

6. The mobile device of claim 1, wherein said second communication protocol is a ZigBee™ protocol.

7. The mobile device of claim 1, wherein said first communication protocol is a wireless local area network protocol.

8. The mobile device of claim 1, wherein said first communication protocol is a cellular telephony protocol.

9. A system comprising:
a server on a network;
two or more smart card readers, each able to be coupled to a smart card that stores identifying data of a person; and
two or more mobile communication devices, each one of said devices comprising:
a first radio through which said one of said devices is able to communicate with said network using a first wireless communication protocol;
a second radio through which said one of said devices is able to communicate with said smart card readers using a second, different, wireless communication protocol;
a processor; and
a memory to store executable code means which, when executed by said processor, transmits information related to a location of said one of said devices through said first radio to said server and transmits an identification of said person through said first radio to said server.

10. The system of claim 9, wherein said one of said devices further comprises a global positioning system receiver to calculate said location.

11. The system of claim 9, wherein said information related to said location is signal strength information from signals received by said one of said devices over said network and said server calculates said location based on locations of access points in said network and said signal strength information.

12. The system of claim 9, wherein said executable code means, when executed by said processor, transmits said information digitally signed by a certificate stored on said smart card and transmits said identification of said person digitally signed by said certificate.

13. The system of claim 9, wherein said second communication protocol is a Bluetooth(® protocol.

14. The system of claim 9, wherein said second communication protocol is an ultra wideband protocol.

15. The system of claim 9, wherein said second communication protocol is a ZigBee™ protocol.

16. The system of claim 9, wherein said first communication protocol is a wireless local area network protocol.

17. The system of claim 9, wherein said first communication protocol is a cellular telephony protocol.

18. A method for identifying and locating a current user of a mobile communication device, the method comprising:
obtaining identification information about said current user over a first wireless communication link from a smart card that stores identifying data of said current user; and
transmitting said identification information and location information about said device to a server over a communication link, at least a portion of which is a second wireless communication link.

19. The method of claim 18, further comprising:
calculating said location information using global positioning system signals received by said device.

20. The method of claim 18, further comprising:
digitally signing said location information prior to transmission using a certificate stored on said smart card, and digitally signing said identification information prior to transmission using said certificate.
